(19) United States
(12) Patent Application Publication
(10) Pub. No.: US 2013/0227158 A1
(43) Pub. Date: Aug. 29, 2013

(54) MEDIA-QUALITY ADAPTATION MECHANISMS FOR DYNAMIC ADAPTIVE STREAMING

(71) Applicant: STMicroelectronics S.r.I., (US)

(72) Inventors: Konstantin MILLER, Berlin (DE); Emanuele QUACCHIO, Torino (IT)

(73) Assignee: STMICROELECTRONICS S.R.L., Agrate Brianza (IT)

(21) Appl. No.: 13/775,885

(22) Filed: Feb. 25, 2013

Related U.S. Application Data
(60) Provisional application No. 61/602,911, filed on Feb. 24, 2012.
(60) Provisional application No. 61/642,365, filed on May 3, 2012.

(51) Int. Cl. H04L 29/06

(52) U.S. Cl. CPC H04L 65/60
USPC 709/231

(57) ABSTRACT

In an embodiment, a control unit includes a determiner and a requestor. The determiner is configured to determine media-data rate in response to the network throughput and one of multiple fill ranges to which a level of a buffer corresponds, and the requestor is configured to request a media-file segment having the determined media-data rate. For example, such a control unit may be able to control the streaming of a video file in a way that reduces or prevents buffer underflows (i.e., video “freezes”), reduces the start-up delay, and that reduces the frequency of changes from one quality level (e.g., resolution) to another quality level, while streaming the highest-quality version of the video file that the data throughput allows. That is, the control unit seeks to maximize the streamed video quality while minimizing the number of buffer underflows, the number of changes in the streamed resolution caused by changes in the throughput, and the start-up delay.

### PRIORITY CLAIM

The present application claims the benefit of copending U.S. provisional patent application Ser. No. 61/602,911 filed Feb. 24, 2012; the present application also claims the benefit of copending U.S. Provisional Patent Application Ser. No. 61/642,365 filed May 3, 2012; all of the foregoing applications are incorporated herein by reference in their entireties.

### SUMMARY

In an embodiment, a control unit includes a determiner and a requestor. The determiner is configured to determine an encoding media-data-rate in response to the available network throughput and one of multiple fill ranges to which a level of a buffer corresponds, and the requestor is configured to request a segment of a media file, the segment having the determined encoding media-data-rate.

For example, an embodiment of such a control unit may be able to control the streaming of a video file in a way that reduces or prevents the number of buffer underflows (i.e., video “freezes”) and the number of switches between versions of the video file while streaming the highest-quality version of the video file that the data throughput to the streaming device allows. That is, the control unit seeks to maximize the streamed quality while minimizing the number of buffer underflows, the number of changes in the streamed quality caused by changes in the throughput, and the start-up delay. Viewed another way, one function that the control unit can be configured to perform is to filter spikes and other higher-frequency changes from the throughput, and to use this filtered throughput to determine which quality of the video file to stream at any given time.

### BRIEF DESCRIPTION OF THE DRAWINGS

FIG. 1 is a diagram of a system for storing multiple quality versions of a media file, for streaming segments from one or more of the versions, and for rendering the streamed segments, according to an embodiment.

FIG. 2 is a diagram of the streaming and rendering unit of the system of FIG. 1, according to an embodiment.

FIG. 3 is a diagram of the ranges within which the fill level of the buffer of FIGS. 1 and 2 my fall, according to an embodiment.

FIG. 4 is a flow diagram of an algorithm that the adaptation control unit of FIGS. 1 and 2 is configured to implement for streaming segments of a media file, according to an embodiment.

FIG. 5 is a flow diagram of the startup-streaming-phase step of FIG. 4, according to an embodiment.

FIG. 6 is a flow diagram of the transfer-to-ongoing-streaming-phase step of FIG. 5, according to an embodiment.

FIG. 7 is a flow diagram of the ongoing-streaming-phase step of FIG. 4, according to an embodiment.

FIGS. 8A and 8B are plots of an example data throughput to the client of FIG. 1, of a corresponding fill level of the buffer of FIGS. 1-2, and of a corresponding segment data rate determined by the adaptation control unit of FIGS. 1-2, according to an embodiment.

FIGS. 9A and 9B are plots of another example data throughput to the client of FIG. 1, of a corresponding fill level of the buffer of FIGS. 1-2, and of a corresponding segment data rate determined by the adaptation control unit of FIGS. 1-2, according to an embodiment.

FIGS. 10A and 10B are plots of yet another example data throughput to the client of FIG. 1, of a corresponding fill level of the buffer of FIGS. 1-2, and of a corresponding segment data rate determined by the adaptation control unit of FIGS. 1-2, according to an embodiment.

FIGS. 11A and 11B are plots of respective example data throughputs to two clients like the client of FIG. 1, of corresponding fill levels of two respective buffers like the buffer of FIGS. 1-2, and of corresponding segment data rates determined by the two respective adaptation control units like the control unit of FIGS. 1-2, according to an embodiment.

### DETAILED DESCRIPTION

Media files, such as video files, are available for streaming over a network, such as the internet, using a rendering device such as a smart phone, smart television, personal computer, laptop computer, and computer pad. “Streaming,” in this context, typically means downloading a media file and rendering it in real time.

A popular technology used to stream video files, such as movies and television programs, is Adaptive Hypertext Transfer Protocol (HTTP) streaming.

Recently, engineers developed a standard, MPEG Dynamic and Adaptive Streaming over HTTP (DASH), to govern Adaptive HTTP streaming. The DASH standard is designed around the concept of dividing a video file into multiple segments that are each a respective portion (e.g., in the range of several seconds, for example, in an approximate range of one to twenty seconds) of the video file. Furthermore, a server may store multiple versions of a video file, each version having a different quality level; for example, each version may have a different spatial resolution. Therefore, forming each of the file versions from file segments may allow a client to more easily switch from one quality-level (e.g., one resolution) version of a video file to another quality-level version of the video file in response to changes in the data throughput to the client (or the data throughput to the rendering application if the client is running multiple applications that are sharing the network bandwidth). For example, suppose that when initially streaming a movie, the throughput to a client is 10 Megabits per second (MB/s), which is sufficient for the client to stream segments of the highest-quality version of the movie that is available on the server. Then, suppose at some time later the throughput decreases to only 1 MB/s, which is sufficient for the client to stream only segments of the lowest-quality version of the movie that is available on the server. For example, more devices may connect to the client's network, thus reducing the per-client data throughput from 10 MB/s to 1 MB/s. In at least some prior systems, the client would either be forced to “freeze” the video while it replenished the video buffer with a succeeding portion of the movie, or to start streaming a lower-quality version of the movie from the beginning, thus forcing the viewer to watch at least a portion of the movie more than once.

One theory that drove the development of the MPEG-DASH standard is that switching from one quality level (e.g., one resolution) to another quality level (e.g., another resolution) may be less annoying to a viewer than video “freeze” or starting a file over again from the beginning.

Therefore, it is envisioned that a client that is compatible with the MPEG-DASH standard may switch from streaming segments of a higher-quality version of a video file to streaming segments of a lower-quality version of the video file dynamically, i.e., “on the fly,” so as to reduce or eliminate video “freeze” or video restart. Thus, in the above example, an MPEG-DASH compatible client may switch from streaming segments of the highest-quality version of a video file to streaming segments of the lowest-quality version of the video file in response to the client throughput decreasing from 10 MB/s to 1 MB/s.

Then, after the throughput recovers (if it recovers), it is envisioned that a client that is compatible with the MPEG-DASH standard may switch back from streaming segments of a lower-quality version of a video file to streaming segments of a higher-quality version of the video file, also dynamically. Thus, in the above example, when the throughput increases significantly above 1 MB/s, a DASH compatible client may switch from streaming segments of the lower-quality version of a video file to streaming segments of a higher-quality version of the video file in response to the client throughput increasing.

Furthermore, although switching from one quality level to another quality level may be less annoying to a viewer than video “freeze” or video restart, such switching may, nonetheless, still annoy a viewer.

Therefore, it is envisioned that a client that is compatible with the MPEG-DASH standard may also act to reduce or minimize the frequency at which the client switches from streaming segments of one quality level of a video file to streaming segments of another quality level of the video file.

Following is a description of embodiments of a MPEG-DASH compatible system, and of components/techniques that a DASH compatible client may include/use to determine if and when to switch from streaming segments from one quality-level version of a media file to streaming segments from another quality-level version of the file, and also to determine if and when to delay the streaming of a next file segment.

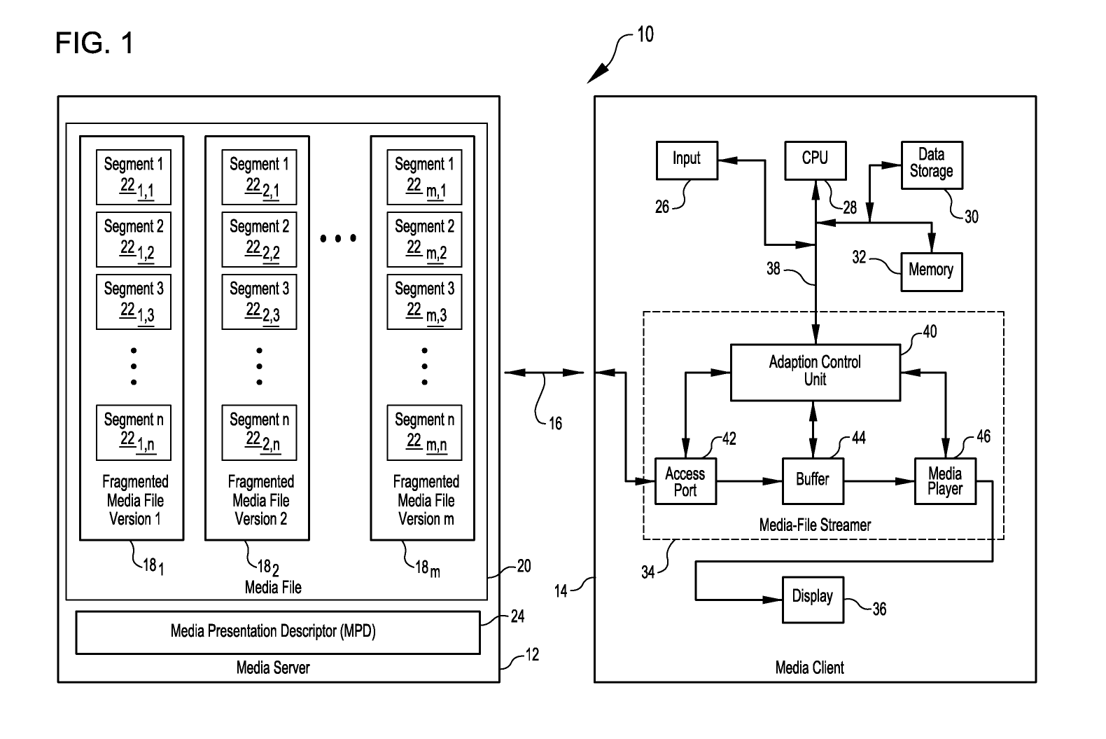

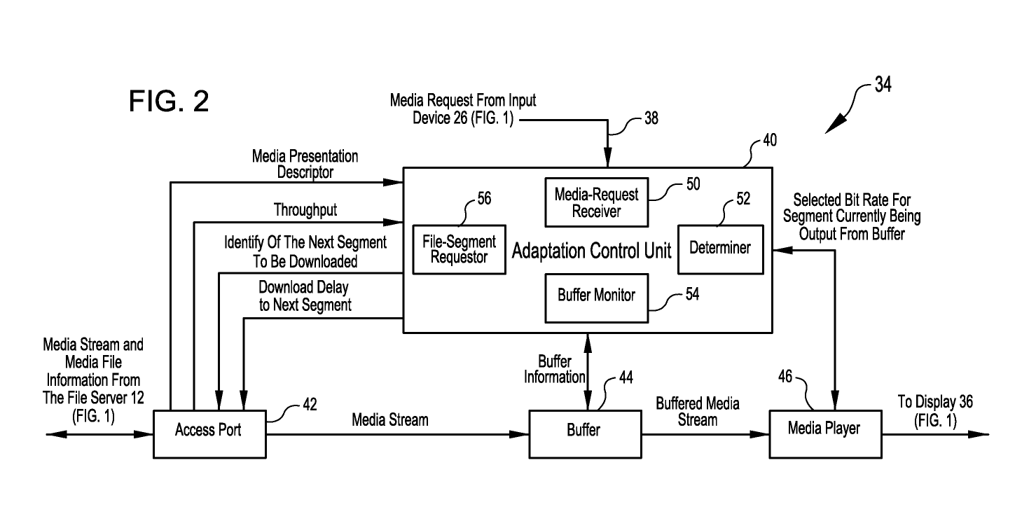

FIG. 1 is a diagram of a media-file-streaming system 10, which is compatible with the MPEG-DASH standard, according to an embodiment.

The system 10 includes a media-file server 12 and a media-file-streaming client 14, which are configured to communicate with one another via a channel or network 16, which channel or network may include the internet.

The server 12 is configured to store multiple versions 18₁-18ₘ of a media file 20, such as a movie, television program, or sound recording—although, hereinafter, the media file is sometimes described as being a video file, it is understood that the principles described herein may be applicable to other types of media files. For example, each version 18 of a movie file 20 may have a different quality level (e.g., spatial resolution, frame rate, or color palette) than the other versions 18. Furthermore, although the server 12 is described as storing one media file 20, it may store more than one media file.

Each version 18 of the media file 20 is fragmented into, i.e., formed from, a respective group of n file segments 22_{a,1}-22_{a,n}. For example, the version 18₁ of the media file 20 includes segments 22_{1,1}-22_{1,n}, the version 18₂ includes segments 22_{2,1}-22_{2,n}, and the version 18ₘ includes segments 22_{m,1}-22_{m,n}.

Each media-file segment 22 has a time duration, or length, e.g., in a range of several seconds, for example, in an approximate range of one to twenty seconds; for example, where the media file 20 is a movie, each segment of a version 18 of the media file contains data that represents a respective time portion (e.g., a ten-second portion) of the movie.

Furthermore each file segment 22 has a same time length as the corresponding segments 22 in the other file versions 18. For example, the segment 22_{1,1} has the same time length as the segments 22_{2,1}-22_{m,1}, the segment 22_{1,2} has the same time length as the segments 22_{2,2}-22_{m,2}, and so on, but the segment 22_{1,1} need not have the same time length as the segment 22_{2,2}. This characteristic allows the client 14 to switch between file versions 18 on a segment-by-segment basis as is described below in conjunction with FIGS. 2-7. In an embodiment, however, all segments 22 of all file versions 18 have the same time length.

But where the file segments 22 are of media-file versions 18 having different quality levels, then the data lengths/sizes of corresponding segments may be different. For example, suppose that the media file 20 is a video file, and the file version 18₁ has the highest resolution, the version 18₂ has the next-highest resolution, and the version 18ₙ has the lowest resolution. Because at least corresponding ones of the segments 22 have the same time length, then, to accommodate the different resolutions, each of these corresponding segments has a different data size (assuming no fill data is added to make the segments the same data size). Therefore, the segment 22_{1,1} contains more data (and, therefore, has a larger data size) than the segment 22_{1,2}, which contains more data (and, therefore, has a larger data size) than the segment 22_{1,3} (not shown in FIG. 1), and so on.

Consequently, because where the file versions 18 have different quality levels corresponding ones of the segments 22 have the same time length but different data sizes, the rate at which the client 14 consumes the data within one corresponding segment is different than the rate at which the client consumes the data within another corresponding segment. Using the above example where the media file 20 is a video file and the file version 18₁ has the highest resolution, the version 18₂ has the next-highest resolution, and so on, this means that the rate (e.g., in bits per second) at which the client 14 consumes the data within the segment 22_{1,1} is higher than the rate at which the client consumes the data within the segment 22_{1,2}, and so on.

Furthermore, this means that the client 14 needs a higher data throughput to stream file segments 22 having a higher media-data rate than it needs to stream segments having a lower media-data rate. Using the above example where the media file 20 is a video file and the file version 18₁ has the highest resolution, the version 18₂ has the next-highest resolution, and so on, this means that the client 14 needs a higher throughput (e.g., in bits per second) to stream the segments 22 of the file version 18₁ than it needs to stream the segments of the file version 18₂, and so on.

The media server 12 also stores a respective media presentation descriptor (MPD) 24 for each stored media file 20, where the MPD describes its corresponding media file. For example, the MPD 24 may describe the content (e.g., movie, television program, music) of the media file 20, the number of versions 18 of the file, the respective quality level (in terms of, e.g., resolution, frame rate, color palette, or other characteristics) of each version, the number of segments 22 in each version, the time lengths and data sizes of the segments, and, the media-data rate of each segment.

Still referring to FIG. 1, the client 14 includes an input device 26, a central processing unit (CPU) 28, a data-storage device 30, a memory 32, a media-file streamer 34, and a display 36; at least the input device, the CPU, data-storage device, memory, and streamer are coupled to one another via a bus 38. The client 14 may also include other components that are omitted from this description for brevity. Furthermore, the client 14 may be any type of device capable of rendering a media file, such as, for example, a smart phone, laptop, personal computer, television, pad computer, or sound-recording player.

The input device 26 is configured to receive data or instructions from a user of the client 14, and to provide this data or these instructions to the bus 38 for consumption by other components of the client 14 that are coupled to the bus. For example, the input device 26 may receive a user's request to stream a media file 20 from the server 12, and may relay this request to the streamer 34 via the bus 38. Examples of the input device 26 include a mouse, keyboard, keypad, touch screen, and a speech-recognition processor.

The central processing unit (CPU) 28 is configured to control, to receive data or instructions from, and to send data or instructions to, the other components of the client 14. For example, the CPU 28 may relay a user's request for streaming a media file 20 from the input device 26 to the streamer 34. Examples of the CPU 28 include a microprocessor or microcontroller that executes program instructions, or a device that includes software, firmware, or hardware, or a combination of two or more of software, firmware, and hardware, that allows the CPU to perform various operations.

The data-storage device 30 is configured to store data for use by the other components of the client 14. For example, the data-storage device 30 may store software that the CPU 28 may execute. Examples of the device 30 include a magnetic-hard-disk drive, a flash drive, an optical-disk drive, or ferromagnetic memory.

The memory 32 is configured to store data and to provide working memory for other components of the client 14. For example, the memory 32 may be configured to load software instructions from the data-storage device 30 such that the CPU 28 can fetch and execute these instructions from the memory. Examples of the memory 32 include volatile memory such as SRAM and DRAM, and nonvolatile memory such as flash memory.

The media-file streamer 34, which is described in more detail in conjunction with FIG. 2, is configured to control the downloading of the segments 22 of the media file 20 in a manner that reduces or eliminates “freezing” of the video (where the media file is a video file), that reduces or minimizes the frequency of switches between different versions 18 of the file, and that otherwise provides a rendering of the media file that is pleasing to a viewer.

The streamer 34 includes an adaptation control unit 40, an HTTP access port 42, a buffer 44, and a media player 46.

The adaptation control unit 40 is configured to control the download/streaming of the file segments 22 as further described below in conjunction with FIGS. 2-7, to control the access port 42, to monitor the buffer 44, and to control the media player 46. The control unit 40 may be implemented in hardware, software, or firmware, or a combination of two or more of hardware, software, and firmware. For example, the control unit 40 may be implemented in software that the CPU 28 is configured to execute.

The HTTP access port 42 is configured to receive the segments 22 of the media file 20 from the server 12 according to the hypertext transfer protocol (HTTP), and may be implemented in hardware, software, or firmware, or a combination of two or more of hardware, software, and firmware. For example, the port 42 may be implemented in software that the CPU 28 is configured to execute.

The buffer 44 is configured to receive and to store the downloaded segments 22 of the media file 20, and to provide these segments, in a temporal order, to the media player 46 for rendering and, where the media file is a video file, for display on the display 36. Furthermore, the buffer 44 is configured to provide, or to otherwise make available, its fill level (i.e., the amount of downloaded data stored in the buffer) to the adaptation control unit 40, or to allow the control unit to monitor the buffer fill level. Moreover, the buffer 44 may be separate from, or disposed within, the memory 32.

And the media player 46 is configured to render the file-segment data from the buffer 44. In this context, “render” means to convert the segment data in the buffer into a format that is compatible with the display 36 (or other rendering device). For example, if the segments 22 of the media file 20 store data in an MPEG format, then the media player 46 is configured to decode/convert this MPEG data into pixel data that is compatible with the display 36. The media player 46 may be implemented in hardware, software, or firmware, or a combination of two or more of hardware, software, and firmware. An example of a software-implemented media player 44 is Windows Media Player®, which is provided by the Microsoft® Corporation.

Still referring to FIG. 1, the display 36 of the client 14 is configured to display still or video images rendered by the media player 46. For example, the display 36 may be a flat-screen television having, e.g., an LCD, LED, or Plasma screen. Alternatively, the client 14 may include other devices, such as speakers, for playing other types of media files such as sound recordings.

Still referring to FIG. 1, alternate embodiments of the system 10 are contemplated. For example, one or more of the access port 42, buffer 44, and media player 46 may not be part of the streamer 34, or the streamer may include components other than these.

FIG. 2 is a diagram of the media streamer 34 of FIG. 1, according to an embodiment.

The adaptation control unit 40 includes a media-request receiver 50, a determiner 52, a buffer monitor 54, and a file-segment requestor 56.

The media-request receiver 50 is configured to receive a request for streaming a media file 20 (FIG. 1) from the input device 26 (FIG. 1) via the bus 38.

The determiner 52 is configured to determine from which file version 18 (FIG. 1) to download the next file segment 22 (FIG. 1) during the streaming of a media file 20 (FIG. 1), whether to delay the download of the next segment, and, if the determiner decides to delay the download, the length of the delay.

The buffer monitor 54 is configured to monitor the fill level, and the fill rate, of the buffer 44. The fill rate is the rate at which file-segment data from the server 12 (FIG. 1) is filling the buffer; a positive fill rate indicates that the buffer is filling (i.e., the access port 42 is loading data into the buffer faster than media player 46 is consuming data from the buffer), a negative fill rate indicates that the buffer is emptying (i.e., the media player is consuming data from the buffer faster than the access port is loading data into the buffer), and a zero fill rate indicates that the level of the buffer is remaining constant.

And the file-segment requester 56 provides the access port 42 with the identity of the file segment 22 (FIG. 1) to download next, whether the access port should delay before initiating the downloading of the next file segment, and, if the requestor indicates a delay, the length of delay.

The adaptation control unit 40 is configured to receive the Media Presentation Descriptor 24 (FIG. 1) from the server 12 (FIG. 1) via the access port 42, and to receive the throughput of the file-segment data (i.e., the rate at which the data within the downloaded file segments is being received by the client 14 (FIG. 1)). The access port 42 may determine the throughput, may obtain the throughput from another source, or may provide information sufficient for the determiner 52 to determine the throughput.

The adaptation control unit 40 also is configured to provide to the media player 46 the media-data rate of the file-segment data currently being output by the buffer 44. For example, if the streamed file is a video file, the control unit 40 may provide the number of bits per second that the media player 46 must consume from the buffer 44, render, and send to the display 36 (FIG. 1) such that the rendered video is displayed at its intended quality level (e.g., its intended resolution).

Still referring to FIG. 2, alternate embodiments of the media-file streamer 34 are contemplated. For example, the adaptation control unit 40 may include components other than, or in addition to, the media-request receiver 50, the determiner 52, the buffer monitor 54, and the file-segment requestor 56, one or more of these aforementioned components may be omitted, or one or more of these aforementioned components may be combined into fewer components. Furthermore, the control unit 40 may generate signals other than, or in addition to, the aforementioned segment identity, download delay, and data-rate signals, one or more of these aforementioned signals may be omitted, or one or more of these aforementioned signals may be combined into fewer signals. Moreover, the control unit 40 may receive signals other than, or in addition to, the aforementioned MPD, throughput, media-file-request, and buffer-information signals, one or more of these aforementioned signals may be omitted, or one or more of these aforementioned signals may be combined into fewer signals. In addition, the buffer monitor 54 may be included in the buffer 44, or the buffer may otherwise provide its fill level and fill rate to the control unit 40. Moreover, one or more components and functions of the streamer 34 may be configurable, for example, by software or firmware.

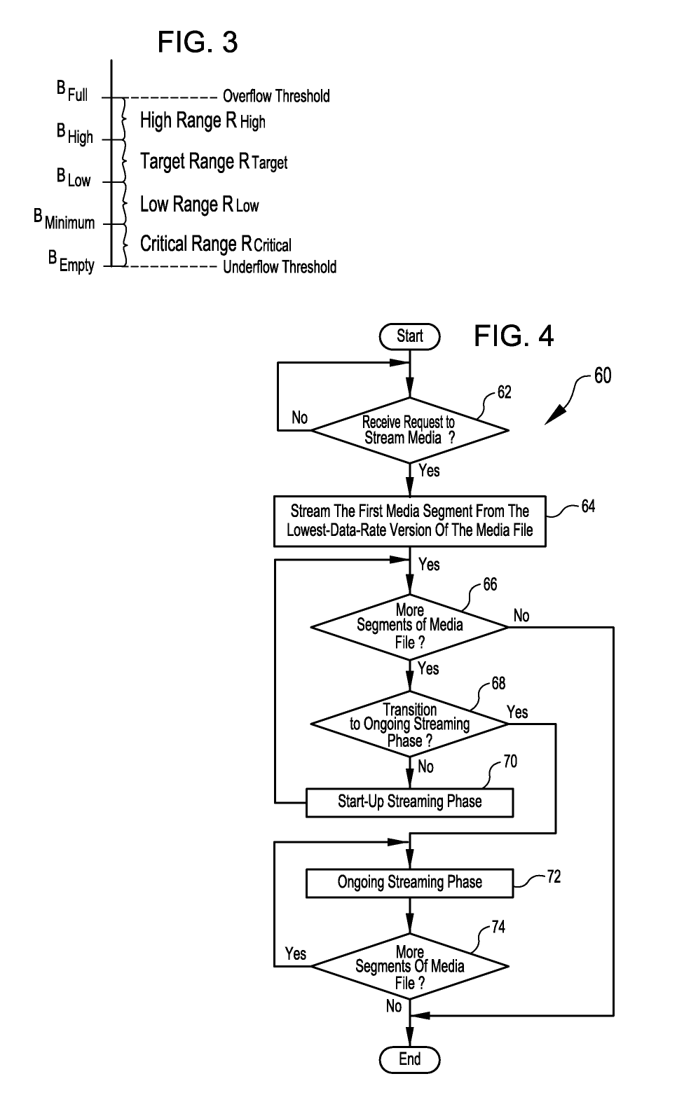

The operation of the adaptation control unit 40 of FIGS. 1-2 is described below in conjunction with FIGS. 3-7, according to an embodiment.

But before describing the operation of the adaptation control unit 40, features that the control unit can be configured to have, or can be configured to implement, are described, according to an embodiment, as follows:

(1) a startup phase of operation in which the control unit starts to stream the video file as soon as possible after a viewer first requests such streaming, and, ramps the quality level of the video up to the maximum quality level supported by the throughput as soon as possible after starting to stream the video, while managing the risks of buffer underflow/overflow;

(2) an ongoing phase of operation that follows the startup phase and during which a primary priority of the control unit is to avoid buffer underflow (i.e., video “freeze”), and secondary priorities are to maximize the quality level of the video and to minimize the frequency of at which the control unit switches from one quality level to another quality level; and

(3) a high degree of configurability/programmability, via, e.g., via software or firmware.

Of course the adaptation control unit 40 may have or implement fewer than all of these features, or may have or implement features other than these features.

FIG. 3 is a plot of fill-level thresholds B and fill-level ranges R for the buffer 44 of FIGS. 1-2, according to an embodiment. These thresholds and ranges may be configurable quantities of the adaptation control unit 40 of FIGS. 1-2.

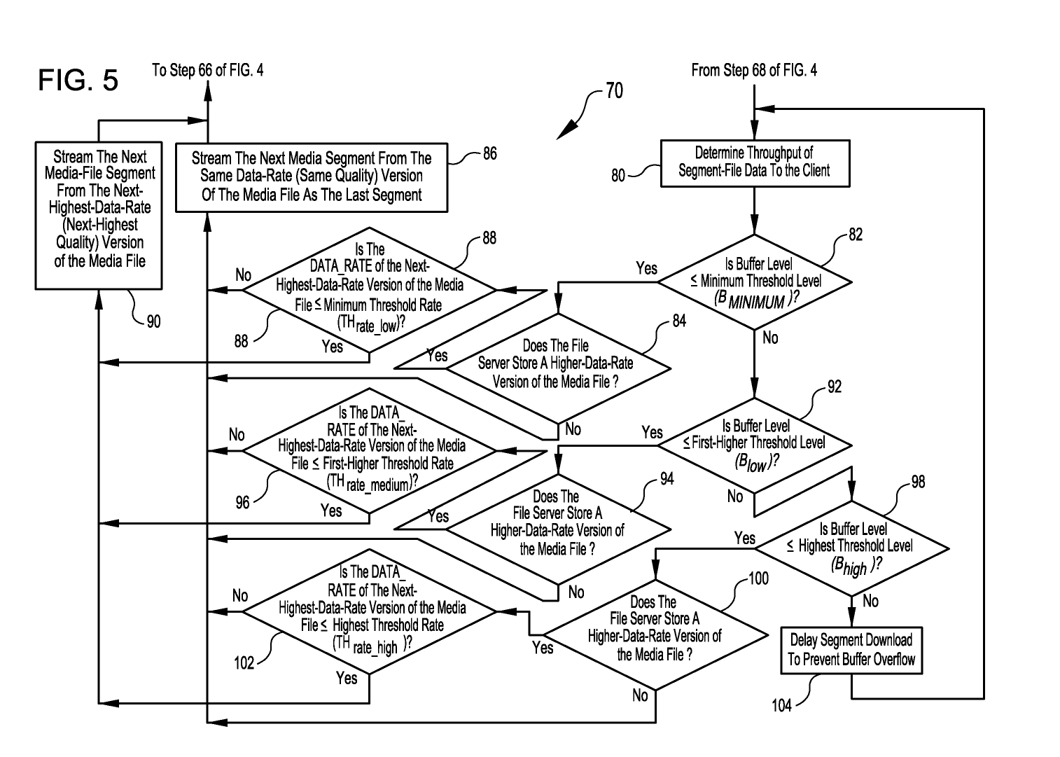

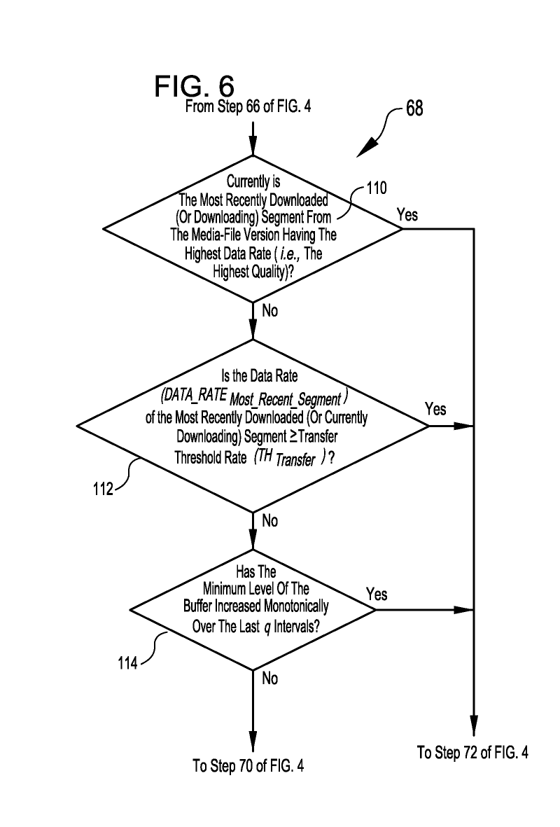

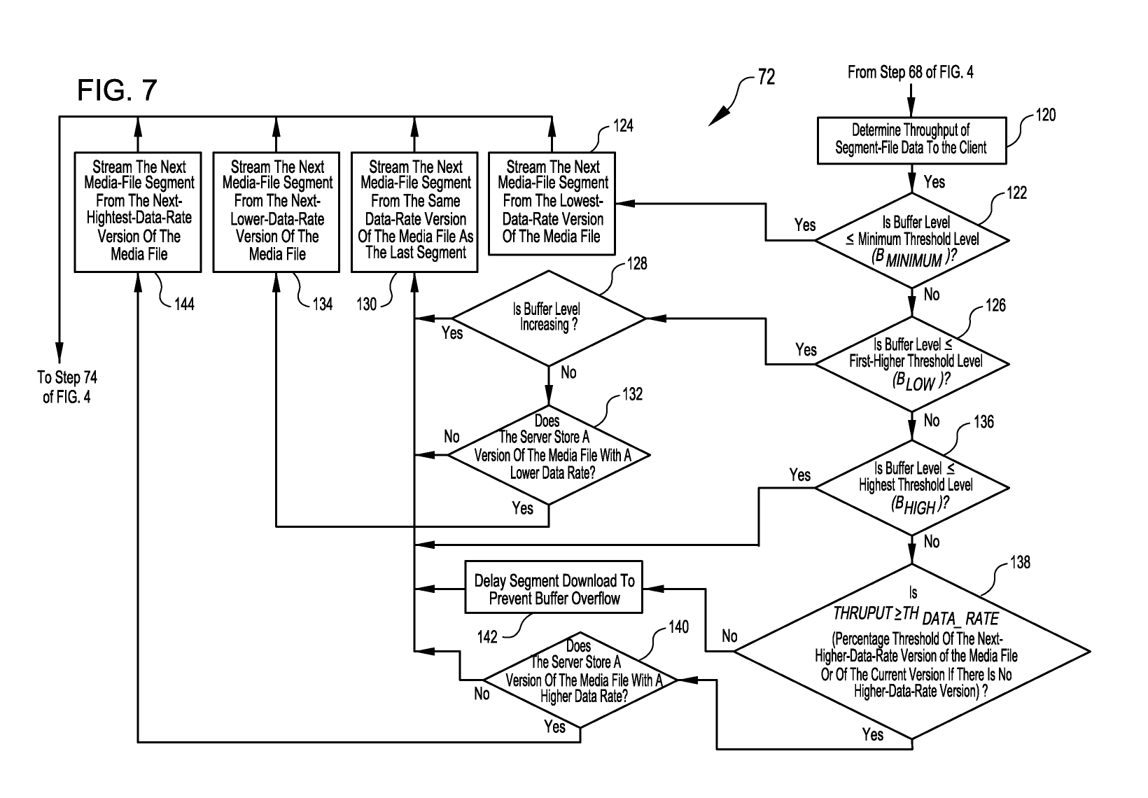

The adaptation control unit 40 (FIGS. 1-2) recognizes the following five buffer-fill-level thresholds B: B_{EMPTY}, which corresponds to the buffer 44 being empty, i.e., containing no file-segment or other data, B_{MINIMUM}, B_{LOW}, B_{HIGH}, and B_{FULL}, which corresponds to the buffer being full, i.e., containing no empty storage locations. If the instantaneous fill level B_{Fill}_{_{—}}_{Level} of the buffer 44 equals B_{EMPTY} while the control unit 40 is streaming a media file, then the buffer underflows, and the viewer experiences a video “freeze;” and if the access port 42 (FIGS. 1-2) attempts to load file-segment data into the buffer while B_{Fill}_{_{—}}_{Level}=B_{FULL}, then buffer overflows, video data may be lost, and the viewer may experience a “jump” or “blip” in the video display. Consequently, as described below in conjunction with FIGS. 4-7, the control unit 40 is configured to try and maintain B_{LOW}<B_{Fill}_{_{—}}_{Level}<B_{HIGH} by controlling the file version 18 from which the control unit downloads the file segments 22, and by controlling the delay between file-segment downloads.

Furthermore, the adaptation control unit 40 (FIGS. 1-2) recognizes the following four buffer-fill-level ranges R, which are defined by the above-described buffer-fill-level thresholds B_{EMPTY}, B_{MINIMUM}, B_{LOW}, B_{HIGH}, and B_{FULL}: R_{CRITICAL}, which corresponds to the instantaneous fill level B_{Fill}_{_{—}}_{Level} of the buffer 44 being closet to the empty threshold B_{EMPTY} (and, thus, being closest to buffer underflow), R_{LOW}, R_{TARGET}, which is the range within which the control unit is configured to try and maintain B_{Fill}_{_{—}}_{Level}, and R_{HIGH}, which corresponds to B_{Fill}_{_{—}}_{Level} being closet to the full threshold B_{FULL} (and, thus, being closest to buffer overflow).

Still referring to FIG. 3, alternate embodiments of the buffer-fill-level thresholds B and the buffer-fill-level ranges R are contemplated. For example, there may be more or fewer than five thresholds B, and more or fewer than four ranges R. Furthermore, although the thresholds B are described as being uniformly spaced from one another, and, therefore, as defining the ranges R as having uniform sizes, the thresholds may be variably spaced from one another, and, therefore, may define the ranges R as having different sizes. Moreover, a range R may be defined by two non-adjacent thresholds B. In addition, the thresholds B_{EMPTY} and B_{FULL} may be designed to have respective tolerances such that when B_{Fill}_{_{—}}_{Level}=B_{EMPTY}, the buffer 44 (FIGS. 1-2) may still contain some segment data, or when B_{Fill}_{_{—}}_{Level}=B_{FULL}, the buffer may still have some empty data-storage locations.

FIG. 4 is a flow diagram 60 of an algorithm that the adaptation control unit 40 (FIGS. 1-2) may implement to stream a media file 20 (FIG. 1), such as a video file, according to an embodiment.

Operation of the adaptation control unit 40 is described in conjunction with FIGS. 1, 2, and 4 according to an embodiment.

Referring to a step 62, the adaptation control unit 40 determines whether a viewer has made a request to stream a media file 20, e.g., via the input device 26. In more detail, the media-request receiver 50 determines whether it has received a request to stream a media file 20, such as a video file. If the receiver 50 has not received a request to stream a media file 20, then the control unit 40 repeats step 62. But if the receiver 50 has received a request to stream a media file 20, then the control unit 40 proceeds to step 64.

Next, at a step 64, to begin rendering the requested media file 20 as soon as possible after the viewer's request while simultaneously managing the risk of the buffer 44 underflowing, the file-segment requestor 56 of the adaptation control unit 40 begins streaming the video file by instructing the access port 42 to download the first segment 22_{n,1} of the video-file version 18ₙ having the lowest quality, and, therefore, having the lowest media-data rate. Because the first downloaded file segment 22_{n,1} has the lowest available media-data rate, the media player 46 streams the segment data from the buffer 44 more slowly, and, thus, empties the buffer more slowly, than if the access port 42 downloaded the first file segment from any of the other higher-quality versions 18 of the media file 20.

Then, at a step 66, the determiner 52 of the adaptation control unit 40 determines whether there are more file segments 22 of the streamed media file 20 to download. If the determiner 52 determines that there are more file segments 22 to download, then the control unit 40 proceeds to a step 68. But if the determiner 52 determines that there are no more file segments 22 of the streamed media file 20 to download (i.e., the control unit 40 has already streamed the entire media file), then the control unit ends the streaming operation, and, although not shown in FIG. 4, may return to step 62.

Next, at the step 68, the determiner 52 determines whether to transition the adaptation control unit 40 from the startup streaming phase to an ongoing streaming phase. If the determiner 52 decides not to transition the control unit 40 to the ongoing streaming phase, then the control unit 40 proceeds to a step 70. But if the determiner 52 decides to transition the control unit 40 to the ongoing streaming phase, then the control unit proceeds to a step 72. Step 68 is described in more detail below in conjunction with FIG. 6.

Then, at the step 70, the adaptation control unit 40 operates according to a startup streaming phase, during which the control unit streams, via the file-segment requestor 56 and the access port 42, a next segment 22 of the requested media file 20. After the file-segment requestor 56 sends a request for the next file segment 22 to the access port 42, the control unit 40 returns to step 66. The startup-streaming-phase step 70 is described in more detail below in conjunction with FIG. 5.

But if, at step 68, the determiner 52 decides transition the adaptation control unit 40 from the startup streaming phase to the ongoing streaming phase, then the control unit proceeds to step 72.

At the step 72, the adaptation control unit 40 operates according to the ongoing streaming phase, during which the control unit streams, via the file-segment requestor 56 and the access port 42, a next segment 22 of the requested media file 20. After the file-segment requestor 56 sends a request for the next file segment 22 to the access port 42, the control unit 40 proceeds to a step 74. The ongoing-streaming-phase step 72 is described in more detail below in conjunction with FIG. 7.

Next, at step 74, the determiner 52 determines whether there are more segments 22 of the streamed media file 20 to download. If the determiner 52 determines that there are more file segments 22 to download, then the control unit 40 returns to step 72. But if the determiner 52 determines that there are no more segments 22 of the streamed media file 20 to download (i.e., the control unit 40 has already streamed the entire media file), then the control unit ends the streaming operation, and, although not shown in FIG. 4, may return to step 62.

Still referring to FIG. 4, alternate embodiments of the algorithm represented by the flow diagram 60 are contemplated. For example, some of the steps may be omitted, other steps may be included, and the order of the steps may be varied. Furthermore, if the throughput becomes so low that the adaptation control unit 40 cannot continue to stream the media file 20, then the control unit may issue an error message to the view via, e.g., the display 46 (FIGS. 1-2).

FIG. 5 is a flow diagram of the startup-streaming-phase step 70 of FIG. 4, according to an embodiment. As discussed above, during the step 70, the adaptation control unit 40 begins streaming the video file 20 as soon as possible after the receiver 50 receives the streaming request, and ramps the quality of the streamed video file up to the maximum quality sustainable by the available throughput as soon as possible without causing buffer underflow or overflow.

Operation of the adaptation control unit 40, while in the startup streaming phase during the step 70, is described in conjunction with FIGS. 1-5, according to an embodiment in which the streamed media file 20 is a video file. But although described in conjunction with streaming a video file, it is understood that the below-described techniques, in unmodified or in modified form, may be useful for streaming other types of media files 20.

At a step 80, the determiner 52 of the adaptation control unit 40 determines the rate, i.e., the throughput THRUPUT, at which data from the most recently streamed (or currently streaming) file segment 20 is loading into the buffer 44 via the access port 42. For example, the determiner 52 may calculate THRUPUT over the previous ten seconds in units of bits/second, and may make this calculation based on the throughput information that the access port 42 provides to the control unit 40. Alternatively, the access port 42 may calculate THRUPUT and provide it to the control unit 40.

Next, at a step 82, the determiner 52 receives the value of the buffer-fill level B_{Fill}_{_{—}}_{Level} from the buffer monitor 54, and determines whether B_{Fill}_{_{—}}_{Level} B_{MINIMUM}; that is, the determiner determines whether B_{Fill}_{_{—}}_{Level} is within the critical range R_{CRITICAL}. If the determiner 52 determines that B_{Fill}_{_{—}}_{Level} B_{MINIMUM} (i.e., that the buffer-fill level is within the critical range R_{CRITICAL}), then the adaptation control unit 40 proceeds to a step 84; otherwise, the control unit proceeds to a step 92.

At the step 84, the determiner 52 determines whether the server 12 stores a version 18 of the video file 20 having a higher media-data rate (and, therefore, a higher quality) than the media-data rate of the video-file version from which the adaptation control unit 40 obtained the most recently downloaded (or currently downloading) video-file segment 22. If the determiner 52 determines that the server 12 does store a video-file version 18 having a higher media-data rate, then the control unit 40 proceeds to a step 88; otherwise, the control unit proceeds to a step 86.

At the step 86, because, at the step 84, the determiner 52 determined that the server 12 does not store a version 18 of the video file 20 having a higher media-data rate than the current version from which the adaptation control unit 40 obtained the most recently downloaded (or currently downloading) file segment 22, the file-segment requestor 56 instructs the access port 42 to download the next file segment from the same file version from which the most recently downloaded file segment was obtained. That is, because the access port 42 is already downloading file segments 22 from the highest-media-data-rate (and, therefore, the highest-quality) version 18 of the video file 20 available on the server 12, the control unit 40 cannot increase the quality of the streamed video.

But if, at the step 84, the determiner 52 determined that the server 12 does store a version 18 of the video file 20 having a higher media-data rate than the version from which the adaptation control unit 40 obtained the most recently downloaded (or currently downloading) file segment 22, then, at the step 88, the determiner 52 determines whether the media-data rate DATA_RATE of the video-file version 18 having the next-higher media-data rate (and thus the next-higher quality level) than the most recently downloaded (or currently downloading) file segment 22 is less than or equal to a minimum threshold rate THᵣₐₜₑ_{_{—}}ₘᵢₙ. For example, THᵣₐₜₑ_{_{—}}ₘᵢₙ may equal a percentage, such as approximately 33%, of THRUPUT. That is, if THRUPUT equals 1 MB/s, then, in an example, THᵣₐₜₑ_{_{—}}ₘᵢₙ would equal 0.33 MB/s. If DATA_RATE>THᵣₐₜₑ_{_{—}}ₘᵢₙ, then, because B_{Fill}_{_{—}}_{Level} is within the range R_{CRITICAL} per the step 82, the adaptation control unit 40 proceeds to the step 86 so as to manage the risk of the buffer 44 underflowing by downloading the next file segment 22 from the same version 18 of the video file 20 as the most recently downloaded (or currently downloading) file segment. But if DATA_RATE≦THᵣₐₜₑ_{_{—}}ₘᵢₙ, then the control unit 40 proceeds to a step 90 because the determiner 52 determines that the risk of buffer underflow is small enough so that the control unit can download the next file segment 22 from the next-higher-quality version 18 of the video file 20.

At the step 90, the file-segment requestor 56 instructs the access port 42 to download the next file segment 22 from the next-higher-quality version 18 of the video file 20 for reasons described in the preceding paragraph.

In summary of the steps 82-90, because B_{Fill}_{_{—}}_{Level} is within the critical range R_{CRITICAL}, the adaptation control unit 40 switches to the next-higher-quality version 18 of the video file 20 only if the data THRUPUT is significantly greater than the DATA_RATE of the next-higher-quality version of the file. That is, the control unit 40 establishes that there is plenty of “cushion” between THRUPUT and DATA_RATE before switching over to the next-higher-quality file version 18.

Still referring to FIGS. 1-5, if, as described above at the step 82, the determiner 52 determines that B_{Fill}_{_{—}}_{Level}>B_{MINIMUM}, i.e., that B_{Fill}_{_{—}}_{Level} is out of the critical range R_{CRITICAL}, then the adaptation control unit 40 proceeds to the step 92.

At the step 92, the determiner 52 determines whether B_{Fill}_{_{—}}_{Level} B_{LOW}; that is, the determiner determines whether B_{Fill}_{_{—}}_{Level} is within the low range R_{LOW}. If the determiner 52 determines that B_{Fill}_{_{—}}_{Level} B_{LOW} (i.e., that the buffer-fill level is within the low range R_{LOW}), then the adaptation control unit 40 proceeds to a step 94; otherwise, the control unit proceeds to a step 98.

At the step 94, the determiner 52 determines whether the server 12 stores a version 18 of the video file 20 having a higher media-data rate (and, therefore, a higher quality) than the data rate of the video-file version 18 from which the adaptation control unit 40 obtained the most recently downloaded (or currently downloading) video-file segment 22. If the determiner 52 determines that the server 12 does store a video-file version 18 having a higher media-data rate, then the control unit 40 proceeds to a step 96; otherwise, the control unit proceeds to the step 86.

At the step 86, because, at the step 94, the determiner 52 determined that the server 12 does not store a version 18 of the video file 20 having a higher media-data rate than the most recently downloaded (or currently downloading) file segment 22, the file-segment requestor 56 instructs the access port 42 to download the next file segment from the same file version from which the most recently downloaded file segment was obtained. That is, because the access port 42 is already downloading file segments 22 from the highest-media-data-rate (and, therefore, the highest-quality) version 18 of the video file 20 available on the server 12, the adaptation control unit 40 cannot increase the quality of the streamed video.

But if, at the step 94, the determiner 52 determined that the server 12 does store a version 18 of the video file 20 having a higher media-data rate than the version from which the adaptation control unit 40 obtained the most recently downloaded (or currently downloading) file segment 22, then, at the step 96, the determiner 52 determines whether the media-data rate DATA_RATE of the video-file version 18 having the next-higher media-data rate (and thus the next-higher quality level) than the media-data rate of the most recently downloaded (or currently downloading) video-file segment 22 is less than or equal to a medium threshold rate THᵣₐₜₑ_{_{—}}_{medium}, which is greater than THᵣₐₜₑ_{_{—}}ₘᵢₙ (described above in conjunction with the step 88). For example, THᵣₐₜₑ_{_{—}}_{medium} may equal a percentage, such as approximately 50%, of THRUPUT. That is, if THRUPUT equals 1 MB/s, then, in an example, THᵣₐₜₑ_{_{—}}_{medium} would equal 0.50 MB/s. If DATA_RATE>THᵣₐₜₑ_{_{—}}_{medium}, then, because B_{Fill}_{_{—}}_{Level} is within the low range R_{Low} per the step 92, the control unit 40 proceeds to the step 86 so as to manage the risk of the buffer 44 underflowing by downloading the next file segment 22 from the same version 18 of the video file 20 as the most recently obtained file segment. But if DATA_RATE THᵣₐₜₑ_{_{—}}_{medium}, then the control unit 40 proceeds to the step 90 because the determiner 52 determines that the risk of buffer underflow is small enough so that the control unit can download the next file segment 22 from the next-higher-quality version 18 of the video file 20.

At the step 90, the file-segment requestor 56 instructs the access port 42 to download the next file segment 22 from the next-higher-quality version 18 of the video file 20 for reasons described in the preceding paragraph.

In summary of the steps 92, 94, 96, 86, and 90, because B_{Fill}_{_{—}}_{Level} is within the low range R_{LOW}, the adaptation control unit 40 switches to the next-higher-quality version 18 of the video file 20 only if the data THRUPUT is greater than the DATA_RATE of the next-higher-quality version of the file. That is, the control unit 40 establishes that there is some “cushion” between THRUPUT and DATA_RATE before switching over to the next-higher-quality file version 18; but the amount of this throughput “cushion” is less than the amount of throughput “cushion” that the control unit 40 provides when B_{Fill}_{_{—}}_{Level} is within the critical range R_{CRITICAL}, because the higher fill level of the buffer 44 also provides some fill-level “cushion” against possible underflow. Therefore, because there is more buffer-fill-level “cushion” when B_{Fill}_{_{—}}_{Level} is within the low range R_{LOW} than when B_{Fill}_{_{—}}_{Level} is within the critical range R_{CRITICAL}, the control unit 40 can relax the throughput “cushion.”

Still referring to FIGS. 1-5, if, as described above in conjunction with the step 92, the determiner 52 determines that B_{Fill}_{_{—}}_{Level}>B_{LOW}, i.e., that B_{Fill}_{_{—}}_{Level} is Out of the critical and low ranges R_{CRITICAL} and R_{LOW}, then the adaptation control unit 40 proceeds to the step 98.

At the step 98, the determiner 52 determines whether B_{Fill}_{_{—}}_{Level}≦B_{HIGH}; that is, the determiner determines whether B_{Fill}_{_{—}}_{Level} is within the target range R_{TARGET}. If the determiner 52 determines that B_{Fill}_{_{—}}_{Level}≦B_{HIGH} (i.e., that the buffer-fill level is within the target range R_{TARGET}), then the adaptation control unit 40 proceeds to a step 100; otherwise, the control unit proceeds to a step 104.

At the step 100, the determiner 52 determines whether the server 12 stores a version 18 of the video file 20 having a higher media-data rate (and, therefore, a higher quality level) than the media-data rate of the video-file version 18 from which the adaptation control unit 40 obtained the most recently downloaded (or currently downloading) video-file segment 22. If the determiner 52 determines that the server 12 does store a video-file version 18 having a higher media-data rate, then the control unit 40 proceeds to a step 102; otherwise, the control unit proceeds to the step 86.

At the step 86, because, at the step 100, the determiner 52 determined that the server 12 does not store a version 18 of the video file 20 having a higher media-data rate than the most recently downloaded (or currently downloading) file segment 22, the file-segment requestor 56 instructs the access port 42 to download the next file segment from the same file version from which the most recently downloaded (or currently downloading) file segment was obtained. That is, because the access port 42 is already downloading file segments 22 from the highest-data-rate (and, therefore, the highest-quality) version 18 of the video file 20 available on the server 12, the adaptation control unit 40 cannot increase the quality of the streamed video.

But if, at the step 100, the determiner 52 determined that the server 12 does store a version 18 of the video file 20 having a higher media-data rate than the version from which the adaptation control unit 40 obtained the most recently downloaded (or currently downloading) file segment 22, then, at the step 102, the determiner 52 determines whether the media-data rate DATA_RATE of the video-file version 18 having the next-higher media-data rate (and thus the next-higher quality level) than the media-data rate of the most recently downloaded (or currently downloading) video-file segment 22 is less than or equal to a high threshold rate THᵣₐₜₑ_{_{—}}_{high}, which is greater than THᵣₐₜₑ_{_{—}}_{medium} (described above in conjunction with the step 96). For example, THᵣₐₜₑ_{_{—}}_{high} may equal a percentage, such as approximately 75%, of THRUPUT. That is, if THRUPUT equals 1 MB/s, then, in an example, THᵣₐₜₑ_{_{—}}_{medium} would equal 0.75 MB/s. If DATA_RATE>THᵣₐₜₑ_{_{—}}_{high}, then, because B_{Fill}_{_{—}}_{Level} is within the target range R_{TARGET} per the step 98, the control unit 40 proceeds to the step 86 so as to manage the risk of the buffer 44 underflowing by downloading the next file segment 22 from the same version 18 of the video file 20 as the most recently obtained file segment. But if DATA_RATE≦THᵣₐₜₑ_{_{—}}_{high}, then the control unit 40 proceeds to the step 90 because the determiner 52 determines that the risk of buffer underflow is small enough so that the control unit can download the next file segment 22 from the next-higher-quality version 18 of the video file 20.

At the step 90, the file-segment requestor 56 instructs the access port 42 to download the next file segment 22 from the next-higher-quality version 18 of the video file 20 for reasons described in the preceding paragraph.

In summary of the steps 98, 100, 102, 86, and 90, because B_{Fill}_{_{—}}_{Level} is within the target range R_{TARGET}, the adaptation control unit 40 switches to the next-higher-quality version 18 of the video file 20 only if the data THRUPUT is greater than the DATA_RATE of the next-higher-quality version of the file. That is, the control unit 40 establishes that there is some “cushion” between THRUPUT and DATA_RATE before switching over to the next-higher-quality file version 18; but the amount of this throughput “cushion” is less than the amount of throughput “cushion” that the control unit 40 provides when B_{Fill}_{_{—}}_{Level} is within the critical range R_{CRITICAL} or the low range R_{LOW}, because the higher fill level of the buffer 44 also provides some buffer-fill-level “cushion” against possible underflow. Therefore, because there is more buffer-fill-level “cushion,” the control unit 40 can relax the throughput “cushion” even more compared to the level of relaxation when B_{Fill}_{_{—}}_{Level} is within the low range R_{LOW}.

Still referring to FIGS. 1-5, if, as described above in conjunction with the step 98, if the determiner 52 determines that B_{Fill}_{_{—}}_{Level}>B_{HIGH}, i.e., that B_{Fill}_{_{—}}_{Level} is out of the critical, low, and target ranges R_{CRITICAL}, R_{LOW}, and R_{TARGET}, then the adaptation control unit 40 proceeds to the step 104.

At the step 104, because B_{Fill}_{_{—}}_{Level}>B_{HIGH}, and, therefore, B_{Fill}_{_{—}}_{Level} is within the high range R_{HIGH}, the adaptation control unit 40 is configured to manage the risk of buffer overflow, i.e., the risk that B_{Fill}_{_{—}}_{Level} will become equal to the full buffer level B_{FULL}. The control unit 40 manages this overflow risk by delaying the download of the next file segment 22 until B_{Fill}_{_{—}}_{Level}<B_{HIGH}. For example, hypothetically speaking, if B_{Fill}_{_{—}}_{Level}=B_{HIGH}, then, assuming that the control unit 40 temporarily stops downloading file segments 22, the media player 46 will empty the buffer 44 in a time T_{B}_{_{—}}_{HIGH}, which depends on the media-data rates of the file segments stored in the buffer (for example, the determiner 52 can be configured to calculate T_{B}_{_{—}}_{HIGH} in response to the media-data rates of the file segments stored in the buffer). Furthermore, as described above in conjunction with FIG. 1, each file segment 22 has a respective time length T_{segment} (e.g., in a range of several seconds, for example, in an approximate range of one to twenty seconds), which is provided to the control unit 40 by the MPD 24. And T_{segment} corresponds to an amount of buffer space, B_{segment}, occupied by a file segment 22, where B_{segment} depends on the media-data rates of the file segments stored in the buffer 44 (for example, the determiner 52 can be configured to calculate B_{segment} for the file segments stored in the buffer). Therefore, in an embodiment, the control unit 40 manages the risk of buffer overflow by delaying the downloading of the next file segment 22 until the buffer monitor 54 determines that B_{Fill}_{_{—}}_{Level}=B_{High}−x·B_{segment}, where x may be an integer such as 1. That is, the control unit 40 delays the downloading of the next file segment 22 until the fill level B_{Fill}_{_{—}}_{Level} of the buffer 44 is x file-segment data sizes B_{segment} (x times the amount of data in a file segment) less than the threshold B_{HIGH}. In an embodiment where the file segments 22 may have different time lengths, then T_{segment} may be selected to equal, for example, the time length of the longest file segment of the video file 20, and B_{segment} may be determined based on this value of T_{segment}.

Next, the adaptation control unit 40 returns to the step 80.

Alternatively, if x and B_{LOW} are selected such that, at the end of the step 104, B_{Fill}_{_{—}}_{Level} is within the target range R_{TARGET}, then the adaptation control unit 40 may proceed from step 104 to step 100, which is described above.

Still referring to FIGS. 1-5, in summary, while operating in the startup-phase-step 70, according to an embodiment, the adaptation control unit 40 is configured to start streaming the video file as soon as possible after receiving the streaming request, and, as soon as possible thereafter, to ramp up to the highest-quality file version 18 that is sustainable by the throughput. And the control unit 40 does this while managing the risk of buffer overflow and underflow in response to at least one of the following parameters: the buffer fill level B_{Fill}_{_{—}}_{Level}, the file-segment-media-data throughput THRUPUT, and the media-data rate DATA_RATE of the next-higher-quality version 18 of the streamed file 20.

Still referring to FIG. 5, alternate embodiments of the step 70 are contemplated. For example, some of the steps of the flow chart of FIG. 5 may be omitted, other steps may be included, and the order of the steps may be varied. Moreover, the algorithm of step 70 may be scaled for use with more or fewer than five buffer-level thresholds or with more or fewer than four buffer-level ranges.

FIG. 6 is a flow diagram of the transfer-to-the-ongoing-phase decision step 68 of FIG. 4, according to an embodiment. As discussed above in conjunction with FIG. 4, at the step 68, the adaptation control unit 40 determines whether to exit the startup phase of operation (step 70 of FIGS. 4-5) and enter the ongoing phase of operation (step 72 of FIGS. 4 and 7).

The operation of the adaptation control unit 40, while making the transfer-to-the-ongoing-phase decision at step 68, is described in conjunction with FIGS. 1-4 and 6, according to an embodiment in which the streamed media file 20 is a video file. But although described in conjunction with streaming a video file, it is understood that the below-described techniques, in unmodified or in modified form, may be useful for streaming other types of media files 20.

At a step 110, the determiner 52 of the adaptation control unit 40 determines whether the control unit is downloading segments 22 from the version 18 of the file 20 having the highest quality level available from the server 12. If the determine 52 determines that the control unit 40 is downloading segments 22 from the file version 18 having the highest quality, then the control unit 40 proceeds to step 72 and begins operating in the ongoing phase. A reason for this is that the control unit 40 has met the startup-phase goal of ramping up to downloading segments 22 of the highest-quality video supported by the throughput THRUPUT; and because there is no higher-quality file version 18, the control unit 40 cannot improve upon this goal. But if the determiner 52 determines that the control unit 40 is not downloading segments 22 from the file version 18 having the highest quality, then the control unit proceeds to a step 112.

At the step 112, the determiner 52 determines whether the media-data rate DATA_RATE_{Most}_{_{—}}_{Recent}_{_{—}}_{Segment} of the most recently downloaded (or currently downloading) file segment 22 is greater than or equal to a transfer threshold TH_{Transfer}, where, for example, TH_{Transfer}=y·THRUPUT, and y is in a range of approximately 80%-90%. If the determiner 52 determines that DATA_RATE_{Most}_{_{—}}_{Recent}_{_{—}}_{Segment}≧TH_{Transfer}, then the adaptation control unit 40 proceeds to the step 72 and begins operating in the ongoing phase. A reason for this is that the control unit 40 has met the startup-phase goal of downloading the highest-quality video supported by the throughput THRUPUT; and because the THRUPUT does not support downloading a higher-quality file version 18, the control unit 40 cannot improve upon this goal. But if the determiner 52 determines that DATA_RATE_{Most}_{_{—}}_{Recent}_{_{—}}_{Segment}<TH_{Transfer}, then the control unit 40 proceeds to a step 114.

At the step 114, the determiner 52 determines whether the minimum level of the buffer 44 (i.e., the minimum value for B_{Fill}_{_{—}}_{Level}) has increased monotonically over the last q intervals. If the minimum value of B_{Fill}_{_{—}}_{Level} has increased from interval to interval over the last q intervals, then the adaptation control unit 40 proceeds to the step 72 and enters the ongoing phase. But if at least one of the intervals shows a decrease in the minimum value of B_{Fill}_{_{—}}_{Level} relative to the previous interval, then the control unit 40 proceeds to the step 70 of FIG. 4, and thus remains in the startup phase. For example, suppose that q=10 and that each interval is one second long—note that an interval does not need to equal the time length of a video segment 22. During each of these one-second intervals, the buffer monitor 54 samples B_{Fill}_{_{—}}_{Level} a number of times. For example, suppose that the buffer monitor 54 samples B_{Fill}_{_{—}}_{Level} at 0.01 second intervals such that the monitor takes one hundred samples of B_{Fill}_{_{—}}_{Level} per each one-second interval. Next, the determiner 52 determines the minimum value of these one hundred samples, and this minimum sample value is the minimum value of B_{Fill}_{_{—}}_{Level} for this interval. The determiner 52 repeats this procedure for the remaining (q−1)=9 intervals such the determiner generates ten minimum values for B_{Fill}_{_{—}}_{Level}, one minimum value for each of the q=10 intervals. Then, the determiner 52 analyzes these minimum values for B_{Fill}_{_{—}}_{Level} in the same temporal order as their corresponding q intervals, and determines whether these temporally ordered minimum values increase monotonically. That is, if the minimum values for B_{Fill}_{_{—}}_{Level} increase from the first interval to the last interval, then the control unit 40 exits the startup phase and enters the ongoing phase by proceeding to the step 72. A reason for this is that because the buffer level B_{Fill}_{_{—}}_{Level} is continually increasing, the risk of underflow is relatively low such that the control unit 40 can enter the ongoing phase. But if there is even a single interval for which the minimum value of B_{Fill}_{_{—}}_{Level} is less than the minimum value of B_{Fill}_{_{—}}_{Level} for a previous interval, then the control unit 40 proceeds to the step 70 and, therefore, remains in the startup phase. The q intervals may overlap, and may be like a pipeline of the most recent intervals such that at each interval, the oldest interval “shifts out” of the q intervals, and the most recent interval “shifts into” the q intervals. Or the q intervals may be non-overlapping, such that the determiner 52 performs the above-described analysis for the q most recent intervals every q^{th} interval, not every interval. For example, where q=10 and the intervals are one second long, the determiner 52 analyzes a first set of ten intervals, analyzes a second set of subsequent intervals where none of the intervals in the second set is the same as any of the intervals in the first set, and so on. The interval time, the amount of times that B_{Fill}_{_{—}}_{Level} is sampled during each interval, and whether the control unit 40 performs this test every interval or for every set of intervals, may all be configurable parameters of the control unit.

Still referring to FIG. 6, alternate embodiments of the decision step 68 are contemplated. For example, some of the steps of the flow chart of FIG. 6 may be omitted, other steps may be included, and the order of the steps may be varied.

FIG. 7 is a flow diagram of the ongoing-streaming-phase step 72 of FIG. 4, according to an embodiment. As discussed above in conjunction with FIG. 4, during the ongoing streaming phase of the step 72, an embodiment of the adaptation control unit 40 is configured to stream the media file 20 at the highest-quality version 18 that is sustainable by the throughput THRUPUT, while managing the risk of overflow and underflow of the buffer 44 (FIGS. 1-2) and the number of switches between different versions of the media file.

Operation of the adaptation control unit 40, while in the ongoing streaming phase of the step 72, is described in conjunction with FIGS. 1-4 and 7, according to an embodiment in which the streamed media file 20 is a video file. But although described in conjunction with streaming a video file, it is understood that the below techniques, in unmodified or in modified form, may be useful for streaming other types of media files.

At a step 120, the determiner 52 of the adaptation control unit 40 determines the rate, i.e., the throughput THRUPUT, at which data from the most recently streamed (or currently streaming) file segment 20 is loading into the buffer 44 via the access port 42. For example, the determiner 52 may calculate THRUPUT over the previous ten seconds in units of bits/second—the time over which THRUPUT is calculated need not be equal to the time length of a file segment 22—and may make this calculation based on the throughput information that the access port 42 provides to the control unit 40. Alternatively, the access port 42 may determine THRUPUT and provide it to the control unit 40.

Next, at a step 122, the determiner 52 receives the value of the buffer-fill level B_{Fill}_{_{—}}_{Level} from the buffer monitor 54, and determines whether B_{Fill}_{_{—}}_{Level}≦B_{MINIMUM}; that is, the determiner determines whether B_{Fill}_{_{—}}_{Level} is within the critical range R_{CRITICAL}. If the determiner 52 determines that B_{Fill}_{_{—}}_{Level}≦B_{MINIMUM} (i.e., that the buffer-fill level is within the critical range R_{CRITICAL}), then the adaptation control unit 40 proceeds to a step 124; otherwise, the control unit proceeds to a step 126.

At the step 124, the file-segment requestor 56 instructs the access port 42 to download the next segment 22 of the video file 20 from the version 18 of the video file having the lowest media-data rate and, therefore, having the lowest quality. Because B_{Fill}_{_{—}}_{Level} is within the critical range R_{CRITICAL}, by downloading the next segment 22 from the lowest-quality file version 18, the adaptation control unit 40 trades off viewing quality for a reduced risk of video “freezing” caused by buffer underflow. As described above in conjunction with FIG. 4, continuously streaming video, even at a reduced quality, may be less annoying to a viewer than discontinuous streaming caused by video “freezing.”

Still referring to FIGS. 1-4 and 7, if, at the step 122, the determiner 52 determines that B_{Fill}_{_{—}}_{Level}>B_{MINIMUM}, i.e., that B_{Fill}_{_{—}}_{Level} is out of the critical range R_{CRITICAL}, then the adaptation control unit 40 proceeds to the step 126.

At the step 126, the determiner 52 determines whether B_{Fill}_{_{—}}_{Level}≦B_{LOW}; that is, the determiner determines whether B_{Fill}_{_{—}}_{Level} is within the low range R_{LOW}. If the determiner 52 determines that B_{Fill}_{_{—}}_{Level}≦B_{LOW} (i.e., that the buffer-fill level is within the low range R_{LOW}), then the adaptation control unit 40 proceeds to a step 128; otherwise, the control unit proceeds to a step 136.

At the step 128, the determiner 52 determines whether the buffer level B_{Fill}_{_{—}}_{Level} is currently increasing or decreasing. In an embodiment, the determiner 52 determines the buffer-level rate (which is the derivative of B_{Fill}_{_{—}}_{Level}) as follows. The determiner 52 first determines the file-segment-data throughput from the access port 42 into the buffer 44 over the time length of the most recently downloaded (or currently downloading) file segment 22. Note that this throughput calculation may be different than the determiner's calculation of THRUPUT, because the determiner 52 may calculate THRUPUT over a time period that is different than the time length of the most recently downloaded (or currently downloading) file segment 22. Next, the determiner 52 determines the rate at which the media player 46 will empty the buffer 44, which rate depends on the media-data rate(s) of the file segment or segments 22 currently stored in the buffer 44. Then, the determiner 52 calculates the buffer fill rate as the difference between the calculated throughput and the buffer empty rate. For example, if the determiner 52 calculates the throughput as 500 bits/second, and the buffer empty rate as 400 bits/second, then the determiner calculates the buffer fill rate equal to +100 bits/seconds, which means that the buffer is going to fill at a rate of 100 bits per second. Conversely, if the determiner 52 calculates the throughput equal to 400 bits/second, and the buffer empty rate equal to 500 bits/second, then the determiner calculates the buffer fill rate equal to −100 bits/seconds, which means that the buffer is going to empty at a rate of 100 bits per second. Furthermore, from just the sign of the buffer fill rate, the determiner 52 can determine whether the buffer is filling (positive sign “+”) or emptying (negative sign “−”).

If, at the step 128, the determiner 52 determines that buffer level B_{Fill}_{_{—}}_{Level} is currently increasing (i.e., that the buffer is filling), then the adaptation control unit 40 proceeds to a step 130; otherwise, the control unit proceeds to a step 132.

At the step 130, because, at the step 126, the determiner 52 determined that the buffer level B_{Fill}_{_{—}}_{Level} is in the low range R_{LOW}, and because, at the step 128, the determiner 52 determined that B_{Fill}_{_{—}}_{Level} is increasing, the file-segment requestor 56 instructs the access port 42 to download the next file segment 22 from the same file version 18 from which the most recently downloaded (or currently downloading) file segment was obtained. That is, the determiner 52 manages the risk of buffer underflow by effectively “waiting to see” if B_{Fill}_{_{—}}_{Level} moves out of the low range R_{Low} and into the target range R_{TARGET} before the determiner switches to a higher-quality (and thus to a higher-media-data-rate) version 18 of the streaming video file 20.

At the step 132, because, at the step 126, the determiner 52 determined that the buffer level B_{Fill}_{_{—}}_{Level} is in the low range R_{LOW}, and because, at the step 128, the determiner determined that B_{Fill}_{_{—}}_{Level} is decreasing, the determiner determines whether the server 12 stores a version 18 of the video file 20 having a lower media-data rate (and, therefore, a lower quality) than the media-data rate of the most recently downloaded (or currently downloading) video-file segment 22. If the determiner 52 determines that the server 12 does store a video-file version 18 having a lower media-data rate, then the adaptation control unit 40 proceeds to a step 134; otherwise, the control unit proceeds to the step 130, which is described above.

At the step 134, because, at the step 126, the determiner 52 determined that the buffer level B_{Fill}_{_{—}}_{Level} is in the low range R_{LOW}, because, at the step 128, the determiner determined that B_{Fill}_{_{—}}_{Level} is decreasing, and because, at the step 130, the determiner determined that the server 12 stores a file version 18 having a lower media-data rate (and, therefore, a lower quality) than the media-data rate of the most recently downloaded (or currently downloading) video-file segment 22, the file-segment requestor 56 instructs the access port 42 to download the next file segment from the file version 18 having the next-lower media-data rate relative to the most recently downloaded (or currently downloading) file segment. That is, the determiner 52 manages the risk of buffer underflow, and, therefore, the risk of video “freeze,” by switching to a lower-quality version 18 of the video file 20, and, therefore, by lowering the rate at which the buffer 44 is emptying, in an attempt to “help” B_{Fill}_{_{—}}_{Level} move out of the low buffer-fill range R_{LOW} and into the target range R_{TARGET}. In this situation, the determiner 52 determines that the potential annoyance to the viewer that switching between file versions 18 may cause is outweighed by reducing the risk of a video “freeze” caused by buffer underflow, where such a “freeze” may be even more annoying to the viewer than the switch between file versions.

In summary of the steps 126-134, because B_{Fill}_{_{—}}_{Level} is within the low range R_{LOW}, the adaptation control unit 40 manages the risk of buffer underflow by staying at the same-quality version 18 of the video file 20 if B_{Fill}_{_{—}}_{Level} is increasing, and by switching to the next-lower-quality version of the video file if B_{Fill}_{_{—}}_{Level} is decreasing.

Still referring to FIGS. 1-4 and 7, if, as described above in conjunction with the step 126, the determiner 52 determines that B_{Fill}_{_{—}}_{Level}>B_{LOW}, i.e., that B_{Fill}_{_{—}}_{Level} is out of the critical and low ranges R_{CRITICAL} and R_{LOW}, then the adaptation control unit 40 proceeds to the step 136.

At the step 136, the determiner 52 determines whether B_{Fill}_{_{—}}_{Level} B_{HIGH}; that is, the determiner determines whether B_{Fill}_{_{—}}_{Level} is within the target range R_{TARGET}. If the determiner 52 determines that B_{Fill}_{_{—}}_{Level} B_{HIGH} (i.e., that the buffer-fill level is within the target range R_{TARGET}), then the adaptation control unit 40 proceeds to the step 130 (described above), in which the control unit does not switch to another file version 18 in an attempt to maintain B_{Fill}_{_{—}}_{Level} within the target range R_{TARGET}; otherwise, the control unit proceeds to a step 138.

Still referring to FIGS. 1-4 and 7, if, as described above in conjunction with the step 136, if the determiner 52 determines that B_{Fill}_{_{—}}_{Level}>B_{HIGH}, i.e., that B_{Fill}_{_{—}}_{Level} is out of the critical, low, and target ranges R_{CRITICAL}, R_{LOW}, and R_{TARGET}, and within the high range R_{HIGH}, then the adaptation control unit 40 proceeds to the step 138.

At the step 138, because B_{Fill}_{_{—}}_{Level}>B_{HIGH}, and, therefore, because B_{Fill}_{_{—}}_{Level} is within the high range R_{HIGH}, the adaptation control unit 40 is configured to manage the risk of buffer overflow, i.e., the risk that B_{Fill}_{_{—}}_{Level} will become equal to the full buffer level B_{FULL}. The control unit 40 manages this risk by first determining whether THRUPUT is greater than or equal to TH_{DATA}_{_{—}}_{RATE}, which is equal to r·DATA_RATE, where r is a percentage (e.g., r=90%), and DATA-RATE is the media-data rate of the next higher-quality version 18 of the streaming video file 20, or is the media-data rate of the currently streaming file version if the currently streaming version is the highest-quality version available on the server 12. If THRUPUT≧TH_{DATA}_{_{—}}_{RATE}, then the control unit 40 proceeds to a step 140; otherwise, the control unit proceeds to a step 142.

At the step 140, the determiner 52 determines whether the server 12 stores a version 18 of the video file 20 having a higher media-data rate (and, therefore, a higher quality) than the media-data rate of the most recently downloaded (or currently downloading) video-file segment 22. If the determiner 52 determines that the server 12 does store a video-file version 18 having a higher media-data rate, then the adaptation control unit 40 proceeds to a step 144; otherwise, the control unit proceeds to the step 130.

At the step 144, because, at the step 136, the determiner 52 determined that B_{Fill}_{_{—}}_{Level}>B_{HIGH} and B_{Fill}_{_{—}}_{Level} is within the high range R_{HIGH}, because, at step 138, the determiner determined that THRUPUT≧TH_{DATA}_{_{—}}_{RATE}, and because, at step 140, the determine determined that the server 12 stores a higher-quality version 18 of the streaming video file 20, the file-segment requestor 56 instructs the access port 42 to download the next file segment 22 from the next-higher-quality version of the video file. That is, in this situation, the adaptation control unit 40 increases the video quality because it can manage the risk of buffer overflow by delaying segment download as described below in conjunction with step 142.

In contrast, at the step 130, because, at the step 140, the determiner 52 determined that the server 12 does not store a version 18 of the video file 20 having a higher media-data rate than the most recently downloaded (or currently downloading) file segment 22, the file-segment requestor 56 instructs the access port 42 to download the next file segment from the same file version from which the most recently downloaded (or currently downloading) file segment was obtained. That is, because the access port 42 is already downloading file segments 22 from the highest-media-data-rate (and, therefore, the highest-quality) version 18 of the video file 20, the adaptation control unit 40 cannot increase the quality of the streamed video.

But if, at step 138, the determiner 52 determines that THRUPUT<TH_{DATA}_{_{—}}_{RATE}, then the adaptation control unit 40 proceeds to the step 142.

At the step 142, because, at step 132, the determiner 52 determined that B_{Fill}_{_{—}}_{Level}>B_{HIGH} (e.g., B_{Fill}_{_{—}}_{Level} is within the high range R_{HIGH}), and because, at step 138, the determiner determined that THRUPUT<TH_{DATA}_{_{—}}_{RATE}, the adaptation control unit 40 manages the risk of buffer overflow (e.g., the risk of B_{Fill}_{_{—}}_{Level}=B_{FULL}) by delaying the download of the next file segment 22 until B_{Fill}_{_{—}}_{Level}<B_{HIGH}.

For example, in an embodiment, hypothetically speaking, if B_{Fill}_{_{—}}_{Level}=B_{HIGH}, then, assuming that the adaptation control unit 40 temporarily stops downloading file segments 22, the media player 46 will empty the buffer 44 in a time T_{B}_{_{—}}_{HIGH}, which depends on the media-data rates of the file segments stored in the buffer (for example, the determiner 52 can be configured to calculate T_{B}_{_{—}}_{HIGH} based on the media-data rates of the file segments stored in the buffer). Furthermore, as described above in conjunction with FIG. 1, each file segment 22 has a respective time length T_{segment} (e.g., ten seconds) which is provided to the control unit 40 by the MPD 24. And T_{segment} corresponds to an amount of buffer space, B_{segment}, occupied by a file segment 22, where B_{segment} depends on the media-data rates of the file segments stored in the buffer 44 (for example, the determiner 52 can be configured to calculate B_{segment} for the file segments stored in the buffer). Therefore, in an embodiment, the control unit 40 manages the risk of buffer overflow by delaying the downloading of the next file segment 22 until the buffer monitor 54 determines that B_{Fill}_{_{—}}_{Level}(t)≦B_{Fill}_{_{—}}_{Level}(t−1)−x·B_{segment}, where B_{Fill}_{_{—}}_{Level}(t−1) is the buffer level before the delay, B_{Fill}_{_{—}}_{Level}(t) is the buffer level after the delay, and x may be an integer such as 1. That is, the control unit 40 delays the downloading of the next file segment 22 until the fill level B_{Fill}_{_{—}}_{Level}(t) of the buffer 44 is at least x file-segment data sizes B_{segment} (x times the amount of media data in a file segment) less than the pre-delay fill level B_{Fill}_{_{—}}_{Level}(t−1). In an embodiment, where the file segments 22 may have different time lengths, then T_{segment} may be selected to equal, for example, the time length of the longest file segment of the video file 20, and B_{segment} may be determined based on this value of T_{segment}.

In another embodiment of the step 142, the adaptation control unit 40 instructs the file-segment requester 56 to delay the download of the next file segment 22 until B_{Fill}_{_{—}}_{Level}(t)≦(B_{Low}+B_{HIGH})/2, where the level (B_{Low}+B_{HIGH})/2 is half way between the level thresholds B_{LOW} and B_{HIGH}.

In yet another embodiment of the step 142, the adaptation control unit 40 instructs the file-segment requestor 56 to delay the download of the next file segment 22 until B_{Fill}_{_{—}}_{Level}(t)≦max([(B_{Fill}_{_{—}}_{Level(t-}1)−x·B_{segment}], [B_{LOW}+B_{HIGH})/2]).

After the step 142, the adaptation control unit 40 proceeds to the step 130 and downloads the next file segment 22 from the version 18 of the video file 20 from which most the recently downloaded (or currently downloading) file segment was obtained.

In summary of the steps 136-142, because B_{Fill}_{_{—}}_{Level} is within the high range R_{HIGH}, if THRUPUT is high enough to sustain downloading the next-higher-quality version 18 of the steaming video file 20, then the adaptation control unit 40 switches to the next-higher-quality version (if there is a higher-quality version). Otherwise, the control unit 40 manages the risk of buffer overflow by delaying the download of the next file segment 22 from the file version 18 from which the most recently downloaded (or currently downloading) file segment was obtained.

Still referring to FIG. 7, alternate embodiments of the step 72 are contemplated. For example, some of the steps of the flow chart of FIG. 7 may be omitted, other steps may be included, and the order of the steps may be varied. Moreover, the algorithm of step 72 may be scaled for use with more or fewer than five buffer-level thresholds B_{EMPTY}, B_{MINIMUM}, B_{LOW}, B_{HIGH}, and B_{FULL}, or with more or fewer than four buffer-level ranges R_{CRITICAL}, R_{LOW}, R_{TARGET}, and R_{HIGH}.

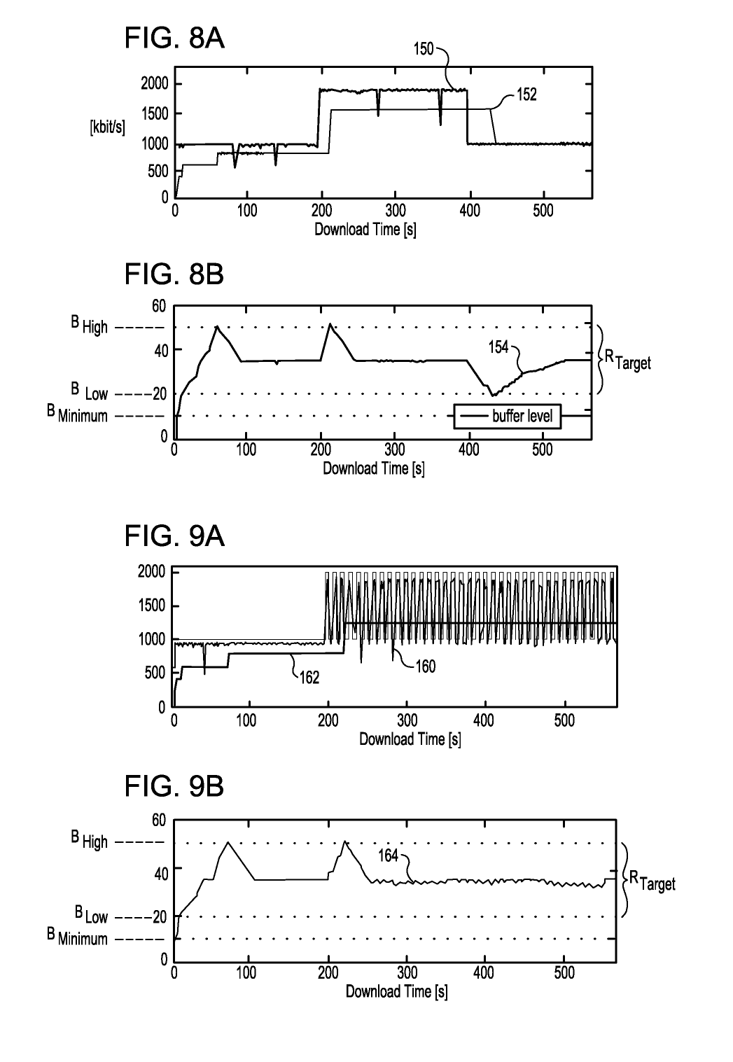

FIG. 8A is a time plot of an example throughput THRUPUT 150, and of a corresponding media-data rate (in this example a media-bit rate) 152 of video-file segments 22 (FIG. 1) that the adaptation control unit 40 (FIGS. 1-2) streams for this THRUPUT, according to an embodiment.

FIG. 8B is a time plot of the fill level B_{Fill}_{_{—}}_{Level} 154 of the buffer 44 (FIGS. 1-2) corresponding to the THRUPUT 150 and to the file-segment media-bit rate 152 of FIG. 8A, according to an embodiment

Referring to FIGS. 8A and 8B, although the media-bit rate 152 of the streamed file segments 22 (FIG. 1) follows the major (i.e., lower-frequency) trends in THRUPUT 150, the adaptation control unit 40 effectively filters the high-frequency spikes in THRUPUT from the media-bit rate so as to reduce the number of switches between quality levels/versions 18 (FIG. 1) of the streamed video file. Furthermore, during a startup phase at the beginning of the streaming, B_{Fill}_{_{—}}_{Level} 154 ramps up, and, in response to this ramping B_{Fill}_{_{—}}_{Level}, the control unit 40 ramps up the media-bit rate 152 until B_{Fill}_{_{—}}_{Level} stabilizes at about the midpoint of the target fill range R_{TARGET}. Thereafter, during an ongoing phase, B_{Fill}_{_{—}}_{Level} 154 varies in response to major trends in THRUPUT 150, and the control unit 40 reacts to these variations in B_{Fill}_{_{—}}_{Level} by switching to downloading file segments 22 having another media-bit rate such that B_{Fill}_{_{—}}_{Level} tends to stabilize back to about the midpoint of R_{TARGET}. Or, viewed in another manner, the control unit 40 effectively implements a feedback loop that adjusts the media-bit rate 152 of the downloaded file segments 22 as needed to maintain B_{Fill}_{_{—}}_{Level} 154 at approximately the midpoint of R_{TARGET}.

FIG. 9A is a time plot of another example throughput THRUPUT 160, and of a corresponding media-data rate (in this example a media-bit rate) 162 of video-file segments 22 (FIG. 1) that the adaptation control unit 40 (FIGS. 1-2) streams for this THRUPUT, according to an embodiment.

FIG. 9B is a time plot of the fill level B_{Fill}_{_{—}}_{Level} 164 of the buffer 44 (FIGS. 1-2) corresponding to the THRUPUT 160 and to the file-segment media-bit rate 162 of FIG. 9A, according to an embodiment

Referring to FIGS. 9A and 9B, in this example, THRUPUT 160 is changing at a high frequency over a significant period of time as compared to the isolated spikes in the THRUPUT 150 of FIG. 8A. But although the media-bit rate 162 of the streamed file segments 22 (FIG. 1) follows the major (i.e., lower-frequency) trends in THRUPUT 160, the adaptation control unit 40 effectively filters the high-frequency variations in THRUPUT from the media-bit rate so as to reduce the number of switches between quality levels/versions 18 (FIG. 1) of the streamed video file. Furthermore, during a startup phase at the beginning of the streaming, B_{Fill}_{_{—}}_{Level} 164 ramps up, and, in response to this ramping B_{Fill}_{_{—}}_{Level}, the control unit 40 ramps up the media-bit rate 162 until B_{Fill}_{_{—}}_{Level} stabilizes at about the midpoint of the target fill range R_{TARGET}. Thereafter, during an ongoing phase, B_{Fill}_{_{—}}_{Level} 164 varies in response to major trends in THRUPUT 160, and the control unit 40 reacts to these variations in B_{Fill}_{_{—}}_{Level} by switching to downloading file segments 22 having another media-bit rate such that B_{Fill}_{_{—}}_{Level} tends to stabilize back to about the midpoint of R_{TARGET}. Or, viewed in another manner, the control unit 40 effectively implements a feedback loop that adjusts the media-bit rate 162 of the downloaded file segments 22 as needed to maintain B_{Fill}_{_{—}}_{Level} 164 at approximately the midpoint of R_{TARGET}.

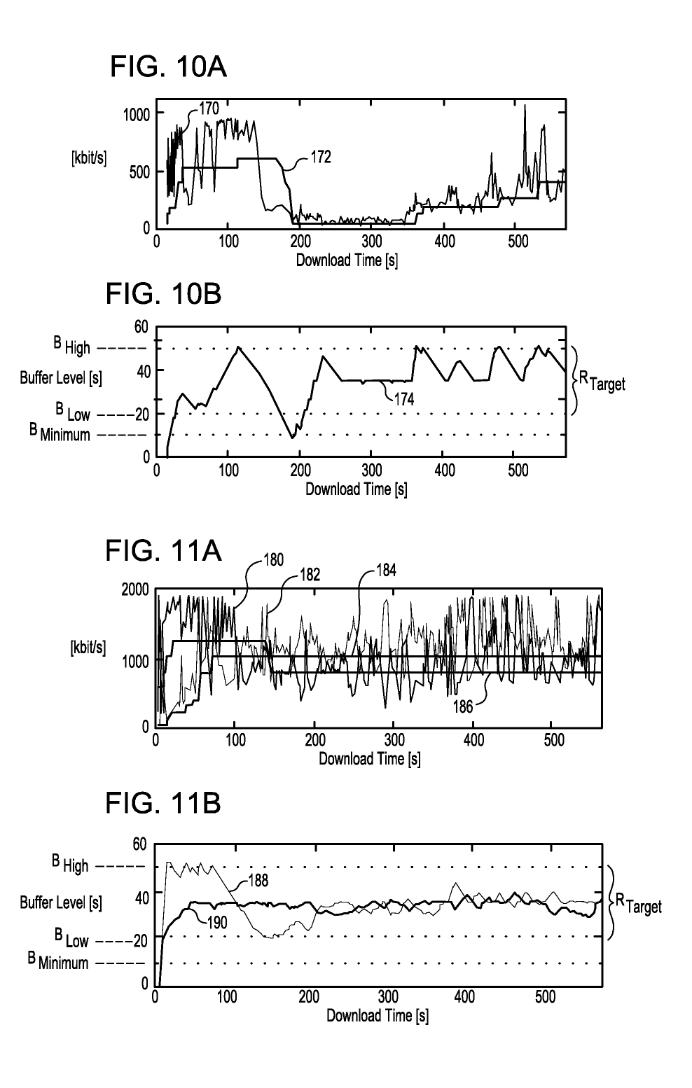

FIG. 10A is a time plot of another example throughput THRUPUT 170, and of a corresponding media-data rate (in this example a media-bit rate) 172 of video-file segments 22 (FIG. 1) that the adaptation control unit 40 (FIGS. 1-2) streams for this THRUPUT, according to an embodiment.

FIG. 10B is a time plot of the fill level B_{Fill}_{_{—}}_{Level} 174 of the buffer 44 (FIGS. 1-2) corresponding to the THRUPUT 170 and to the file-segment media-bit rate 172 of FIG. 10A, according to an embodiment

Referring to FIGS. 10A and 10B, in this example, THRUPUT 170 is very unstable and represents a challenging network condition, as may occur in a network (e.g., a WI-FI hotspot) that handles a lot of random traffic. But although the media-bit rate 172 of the streamed file segments 22 (FIG. 1) follows the major (i.e., lower-frequency) trends in THRUPUT 170, the adaptation control unit 40 effectively filters the high-frequency spikes in THRUPUT from the media-bit rate so as to reduce the number of switches between quality levels/versions 18 (FIG. 1) of the streamed video file. Furthermore, during a startup phase at the beginning of the streaming, B_{Fill}_{_{—}}_{Level} 174 ramps up, and, in response to this ramping B_{Fill}_{_{—}}_{Level}, the control unit 40 ramps up the media-bit rate 172 until B_{Fill}_{_{—}}_{Level} is within the target fill range R_{TARGET}. Thereafter, during an ongoing phase, B_{Fill}_{_{—}}_{Level} 164 varies in response to major trends in THRUPUT 170, and the control unit 40 reacts to these variations in B_{Fill}_{_{—}}_{Level} by switching to downloading file segments 22 having another media-bit rate such that B_{Fill}_{_{—}}_{Level} tends to stay within R_{TARGET}. Or, viewed in another manner, the control unit 40 effectively implements a feedback loop that adjusts the media-bit rate 172 of the downloaded file segments 22 as needed to maintain B_{Fill}_{_{—}}_{Level} 174 approximately within R_{TARGET}.

FIG. 11A is a time plot of two example throughputs THRUPUT 180 and THRUPUT 182, and of two corresponding media-bit rates 184 and 186 of respective video-file segments 22 (FIG. 1) streamed by two adaptation control units 40 (FIGS. 1-2) for THRUPUT 180 and THRUPUT 182, respectively, according to an embodiment. For example, the two control units 40 may be disposed on two respective clients 14 (FIG. 1), which may be part of the same network, and which may be streaming respective video files simultaneously.

FIG. 11B is a time plot of the fill levels B_{Fill}_{_{—}}_{Level} 188 and 190 of the buffers 44 (FIGS. 1-2) respectively corresponding to the THRUPUT 180 and the THRUPUT 182, and respectively corresponding to the file-segment media-bit rates 184 and 186, of FIG. 11A, according to an embodiment

Referring to FIGS. 11A and 11B, in this example, per above, THRUPUT 180 and THRUPUT 182 are very unstable and represent a challenging network condition where two or more clients 14 on a network are simultaneously streaming respective video files—in this example, it is assumed that at least two of the clients include respective adaptation control units 40 (FIGS. 1-2). But although the media-bit rates 184 and 186 of the respective streamed file segments 22 (FIG. 1) follow the major (i.e., lower-frequency) trends in THRUPUT 180 and THRUPUT 182, respectively, the adaptation control units 40 effectively filter the high-frequency spikes in THRUPUT 180 and THRUPUT 182 from the media-bit rates 184 and 186, respectively, so as to reduce the number of switches between quality levels/versions 18 (FIG. 1) of the streamed video files. Furthermore, during a startup phase at the beginning of the streaming, B_{Fill}_{_{—}}_{Level} 188 and B_{Fill}_{_{—}}_{Level} 190 ramp up, and, in response to this ramping of B_{Fill}_{_{—}}_{Level} 188 and B_{Fill}_{_{—}}_{Level} 190, the control units 40 ramp up the respective media-bit rates 184 and 186 until B_{Fill}_{_{—}}_{Level} 188 and B_{Fill}_{_{—}}_{Level} 190 are within their respective target fill ranges R_{TARGET} (in this example, R_{TARGET} is the same for both control units 14, although R_{TARGET} may be different for each control unit). Thereafter, during an ongoing phase, B_{Fill}_{_{—}}_{Level} 188 and B_{Fill}_{_{—}}_{Level} 190 vary in response to major trends in THRUPUT 180 and THRUPUT 182, respectively, and the control units 40 react to these respective variations in B_{Fill}_{_{—}}_{Level} 188 and B_{Fill}_{_{—}}_{Level} 190 by switching to downloading file segments 22 having other media-bit rates such that B_{Fill}_{_{—}}_{Level} 188 and B_{Fill}_{_{—}}_{Level} 190 tend to stay around approximately the midpoint of R_{TARGET}. Because both clients 14 include adaptation control units 40, one client is not consuming a significantly bigger share of the network bandwidth than the other client, as evidenced by the media-bit rates 188 and 190 being relatively close to one another, at least after the startup phase.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated. Moreover, the components described above may be disposed on a single or multiple IC dies to form one or more ICs, these one or more ICs may be coupled to one or more other ICs. In addition, any described component or operation may be implemented/performed in hardware, software, firmware, or a combination of any two or more of hardware, software, and firmware. Furthermore, one or more components of a described apparatus or system may have been omitted from the description for clarity or another reason. Moreover, one or more components of a described apparatus or system that have been included in the description may be omitted from the apparatus or system.

What is claimed is:

1. A control unit, comprising:
a determiner configured to determine a data rate in response to one of multiple fill ranges to which a level of a buffer corresponds; and
a requestor configured to request a segment of a media file, the segment having the determined data rate.

2. The control unit of claim 1 wherein the determiner is configured to determine the data rate in response to a receiving rate at which a port receives a segment of the media file.

3. The control unit of claim 1 wherein the determiner is configured to determine the data rate in response to a buffering rate at which the level of the buffer is changing.

4. The control unit of claim 1 wherein the determiner is configured to determine the data rate in response to another data rate for which segments of the media file are available.

5. The control unit of claim 1 wherein the determiner is configured to determine the data rate in response to a higher data rate for which segments of the media file are available.

6. The control unit of claim 1 wherein:
the determiner is configured to determine a delay in response to the one of the multiple fill ranges to which the level of the buffer corresponds; and
the requestor is configured to request the segment of the media file after the delay.

7. The control unit of claim 1 wherein:
the determiner is configured to determine a delay in response to the one of the multiple fill ranges to which the level of the buffer corresponds; and
the requestor is configured to request that an apparatus on which the segment of the media file is stored send the segment after the delay.

8. The controller of claim 1, further comprising a receiver configured to receive a request for downloading the media file.

9. The controller of claim 1, further comprising a monitor configured to determine the level of the buffer and the one of the multiple fill ranges to which the level of the buffer corresponds.

10. An apparatus, comprising:
an access port;
a buffer coupled to the access port; and
a control unit coupled to the access port and to the buffer, and including
a determiner configured to determine a data rate in response to one of multiple fill ranges to which a level of the buffer corresponds; and
a requestor configured to request, via the access port, a segment of a media file, the segment having the determined data rate.

11. The apparatus of claim 10, further comprising an input device configured to send a request for downloading the media file to the control unit.

12. The apparatus of claim 10, further comprising a processor coupled to the control unit.

13. The apparatus of claim 10 wherein the control unit includes a processor.

14. The apparatus of claim 10, further comprising a player configured to render the segment of the media file.

15. The apparatus of claim 10, further comprising:
wherein the segment of the media file includes a segment of a video file;
a player configured to render the segment of the video file; and
a display coupled to the player and configured to display the rendered segment.

16. The apparatus of claim 10 wherein the control unit includes a processor.

17. The apparatus of claim 10 wherein the control unit includes firmware.

18. The apparatus of claim 10 wherein the control unit includes at least one software instruction.

19. A system, comprising:
a first apparatus configured to store multiple versions of a media file, each file version corresponding to a respective data rate and including a respective set of file segments each having the respective data rate; and
a second apparatus coupled to the first apparatus and including
an access port,
a buffer coupled to the access port, and
a control unit coupled to the access port and to the buffer, and including
a determiner configured to determine a data rate in response to one of multiple fill ranges to which a level of the buffer corresponds, and
a requestor configured to request, via the access port, a segment of one of the versions of the media file from the first apparatus, the segment having the determined data rate.

20. The system of claim 19 wherein the second apparatus is coupled to the first apparatus via the internet.

21. The system of claim 19 wherein the first and second apparati form at least part of a network.

22. The system of claim 19 wherein:
the first apparatus includes a server; and
the second apparatus includes a client.

23. The system of claim 19 wherein the media file includes a video file.

24. A method, comprising:
determining a fill range that corresponds to a level to which a buffer is filled with data from a media file;
determining a media data rate in response to the fill range; and
requesting a next segment of the media file, the next segment having the determined data rate.

25. The method of claim 24, further comprising:
determining a throughput at which data from the media file is being received; and
wherein determining the media data rate includes determining the media data rate in response to the throughput.

26. The method of claim 24, further comprising:
determining a consumption rate at which data in the buffer is being consumed; and
wherein determining the media data rate includes determining the media data rate in response to the consumption rate.

27. The method of claim 24, further comprising:
determining another media data rate for which at least one other segment of the media file is available; and
wherein determining the media data rate includes determining the media data rate in response to the other media data rate.

28. The method of claim 24, further comprising:
determining another higher media data rate for which at least one other segment of the media file is available; and
wherein determining the media data rate includes determining the media data rate in response to the other higher media data rate.

29. The method of claim 24, further comprising:
determining a delay in response to the identified fill range; and
wherein requesting the next segment of the media file includes delaying the request by a period of time approximately equal to the delay.

30. The method of claim 24, further comprising:
determining a delay in response to the identified fill range; and
requesting that an apparatus waits to send the requested next segment of the media file includes by a period of time approximately equal to the delay.

31. The method of claim 24, further comprising:
receiving the requested next segment of the media file; and
rendering the received next segment.

32. The method of claim 24, further comprising:
wherein the media file includes a video file;
receiving the requested next segment of the media file; and
displaying the received next segment.
